(19) United States
(12) Patent Application Publication
(10) Pub. No.: US 2013/0037590 A1
(43) Pub. Date: Feb. 14, 2013

(54) HOLDER APPARATUS FOR MOUNTING A MEDIA DEVICE IN A VEHICLE

(71) Applicant: Seong-Ho YOON, Seoul (KR)

(72) Inventor: Seong-Ho YOON, Seoul (KR)

(73) Assignee: NAMSUNG CO., LTD., Seoul (KR)

(21) Appl. No.: 13/527,835

(22) Filed: Jun. 20, 2012

(30) Foreign Application Priority Data
Aug. 12, 2011 (KR) 10-2011-0080739
May 17, 2012 (KR) 10-2012-0052655

(51) Int. Cl. B60R 7/06

(52) U.S. Cl. 224/483

(57) ABSTRACT

Disclosed herein is a holder apparatus for mounting a portable media device in a vehicle. The holder apparatus includes a holder member to which the portable media device is detachably mounted, a mounting bracket member mounted to a side of audio equipment of a vehicle and to which the holder member is connected, and a connection member connecting the holder member and the mounting bracket member.

### CROSS REFERENCE TO RELATED APPLICATION(S)

This application claims the benefit of Korean Patent Applications No. 10-2011-0080739, filed on Aug. 12, 2011 and No. 10-2012-0052655, filed on May 17, 2012, which are hereby incorporated by reference in its entirety into this application.

### BACKGROUND OF THE INVENTION

1. Technical Field

The present invention relates generally to an apparatus for mounting a media device in a vehicle and, more particularly, to a holder apparatus for simply mounting a media device, such as a navigational instrument, a PMP, a smart phone, etc. in a vehicle.

2. Description of the Related Art

As is well known to those skilled in the art, portable media devices are devices that allow the user to play media such as video, music, or listen to the radio while being mobile. Such portable media devices have been widely distributed these days.

The portable media devices include MP3 players, portable multimedia players (PMPs), smart phones, tablet computers, etc.

The portable media devices can be used in a vehicle while being mounted on a separate holder.

The structure of the holder is such that a portable media device and an electronic device such as a navigational instrument can be detachably mounted, so that the user can use the portable media device and electronic device such as a navigational instrument in a vehicle while mounting them using the holder to suit the user's convenience.

The holder for a portable media device mainly uses a windshield-attached fixture so that it can be used in a vehicle while being attached to the windshield.

However, the holder for a portable media device has the problems of causing an accident to occur because of it being mounted on the windshield so that a driver is impeded from having a secured his view.

Further, there are other problems with the windshield-attached fixture because a residue being left on the windshield disfigures a vehicle and the accident of it falling from the windshield occurs frequently due to its own weight.

Particularly, the windshield-attached fixture easily falls off from the windshield in the wintertime due to a difference in temperature between the inside and the outside of a vehicle interior.

Thus, such falling of the holder for a portable media device from the windshield in the wintertime diverts a driver's attention while a vehicle is traveling, causing a traffic accident to occur.

Further, when the holder for a portable media device falls from the windshield, there are the problems of the portable media device being damaged.

### SUMMARY OF THE INVENTION

Accordingly, the present invention has been made keeping in mind the above problems occurring in the related art, and an object of the present invention is to provide an apparatus for mounting a portable media device in a vehicle, the apparatus being mounted in a vehicle using audio equipment of the vehicle, so that a driver can secure his forward sight and the convenience of use of the portable media device is improved.

In order to accomplish the above object, the present invention provides a holder apparatus for mounting a portable media device in a vehicle, including: a holder member to which the portable media device is detachably mounted; a mounting bracket member mounted to the side of audio equipment of a vehicle and to which the holder member is connected; and a connection member connecting the holder member and the mounting bracket member.

The holder apparatus for a portable media device according to the present invention is secured firmly between the side of the audio equipment of the vehicle and an instrument panel, having the effect of mounting a portable media device in a vehicle in a simple, safe manner.

Further, the holder apparatus has the effect of simply mounting the portable media devices of diverse sizes without leaving an unnecessary stain on the surface of a vehicle.

Furthermore, the holder apparatus has the effect of minimizing obstruction of the windshield from view, thereby improving safety while a vehicle is traveling.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of the interior of a vehicle in which a holder apparatus of the present invention is mounted;

FIG. 2 is a perspective view of the structure of the holder apparatus;

FIG. 3 is a perspective view of the mounted state of the holder apparatus;

FIGS. 4 and 5 are views of an example of a holder member of the holder apparatus;

FIG. 6 is an exploded perspective view of the holder member;

FIG. 7 is a front view of the operation of the holder member; and

FIG. 8 is a perspective view of the state of the holder member that has been separated from a connection member.

### DESCRIPTION OF THE PREFERRED EMBODIMENTS

Reference now should be made to the drawings, throughout which the same reference numerals are used to designate the same or similar components.

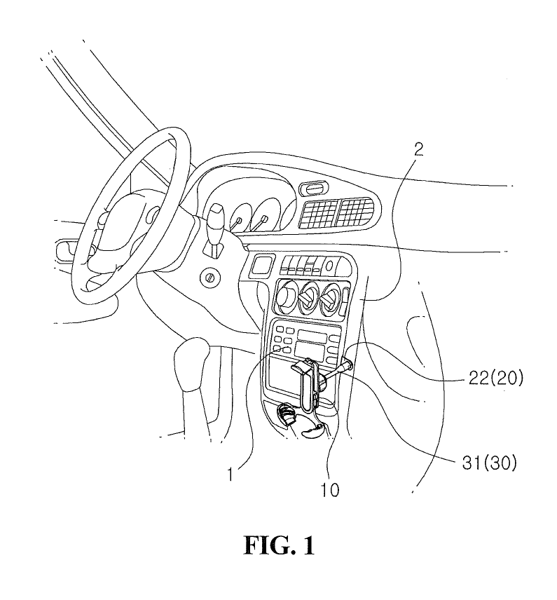

Referring to FIG. 1, audio equipment 1 of a vehicle is mounted to an instrument panel 2 between a driver seat and a passenger seat. The instrument panel 2 has a mounting space between the driver seat and the passenger seat to accommodate the audio equipment 1.

The side of the audio equipment 1 is provided with a mounting hole so that the audio equipment can be mounted to the instrument panel using the mounting hole.

According to the present invention, a holder apparatus for a portable media device includes a mounting bracket member 20 which is mounted to the side of the audio equipment, protruding to the outside between the audio equipment 1 and the instrument panel 2. A holder member 10 for holding a portable media device is connected to the mounting bracket member 20 by a connection member 30.

The portable media devices may include smart phones, tablet computers, cellular phones, MP3 players, portable multimedia players (PMPs), etc.

While a smart phone will be described by way of example of a portable media device that is mounted to the holder apparatus, other portable media devices can be used.

The mounting bracket member 20 is mounted to the side of the audio equipment 1 by bolt coupling. Here, the mounting bracket member 20 is preferably bolt-coupled to the audio equipment 1 through the mounting hole. The mounting hole is provided at the audio equipment 1 in order to mount the audio equipment 1 to the instrument panel 2.

Since the mounting bracket member 20 is bolt-coupled to the audio equipment through the mounting hole, the coupling can be done without a separate additional structure.

The mounting bracket member 20 is mounted to the side of the audio equipment 1 in such a manner as to protrude to the outside of the instrument panel 2 between the audio equipment 1 and the instrument panel 2 so that the connection member 30 is connected to an end of the protrusion.

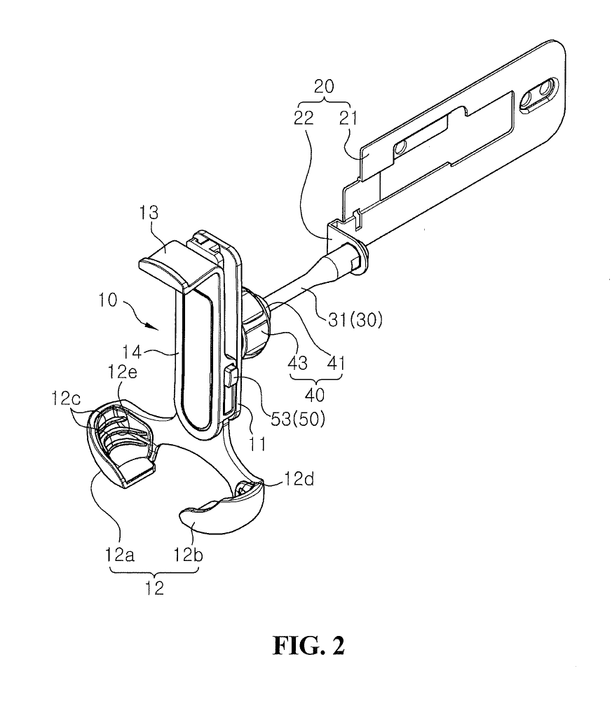

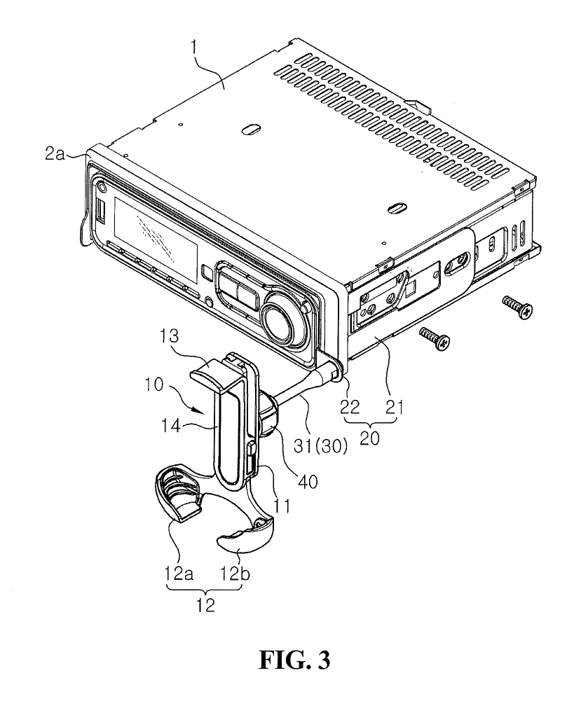

An exemplary embodiment will now be described with reference to FIGS. 2 and 3.

The holder apparatus for a portable media device may further include an audio frame 2a which is provided at the mounting space for audio equipment, which is defined in the instrument panel, so as to surround the circumference of the audio equipment 1.

A portion of the mounting bracket member 20 protrudes to the interior of a vehicle between the side of the audio equipment 1 and the instrument panel 2. The connection member 30 is connected to an end of this protrusion of the mounting bracket member 20.

The mounting bracket member 20 includes a bracket panel part 21 that is mounted to the side of the audio equipment 1, and a connection bracket part 22 that is bent from one side of the bracket panel part 21 and protrudes toward the inside of the vehicle.

The connection bracket part 22 protrudes from the end of the bracket panel part 21 and the holder member 10 is connected to the end of the connection bracket part 22.

The connection member 30 may be a connection rod 31 both ends of which are connected to the connection bracket part 22 and the holder member 10, respectively.

The holder member 10 includes a base body part 11 to which the connection member 30 is connected, a support part 12 which is provided at a lower portion of the base body part 11 to support the bottom of a portable media device 3, and a clamp part 13 which is provided at an upper portion of the base body part 11 to support the top of the media device 3.

It should be noted that the upper and lower portions of the base body part 11 are merely provided to define a reference of direction, so their functions may be interchanged.

The holder member 10 may further include a movable body part 14 which is movably provided at the base body part 11 and with which either of the support part 12 and the clamp part 13 is integrally formed.

For example, the case will be exemplified in which the clamp part 13 is integrally formed on the upper portion of the movable body part 14. The movable body part 14 is movably coupled to the base body part 11 so as to adjust a distance between the support part 12 and the clamp part 13 in order to firmly hold the media device 3 supported by the support part 12.

The support part 12 has a first edge support 12a which is provided at one side of a lower portion of the base body part 11 to support one side edge of the media device 3, and a second edge support 12b which is provided at another side of the lower portion of the base body part 11 to support another side edge of the media device 3.

The first and second edge supports 12a and 12b are spaced apart from each other by a distance at the lower portion of the base body part 11 so as to support opposite side edges of the media device 3, respectively.

The first and second edge supports 12a and 12b support the opposite side edges of a lower portion of the media device 3 whose shapes are generally rectangular, thereby allowing the media device 3 to be held more stably.

The edge of the media device means a portion at which two of four sides forming a contour of a front surface of the media device 3 intersect with each other.

That is, the first and second edge supports 12a and 12b concurrently support lower and side faces at opposite portions of the media device 3 so as to stably hold the media device 3.

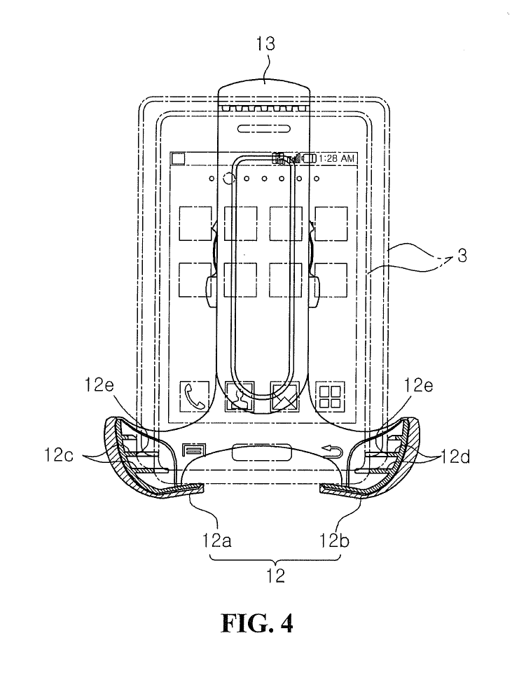

Referring to FIG. 4, the first edge support 12a is provided with a plurality of first support plates 12c that are vertically arranged at distances, and the second edge support 12b is provided with a plurality of second support plates 12d that are vertically arranged at the same distances as those of the first support plates. The distances between the plurality of first and second support plates 12c and 12d increase from the bottom to the top.

That is, the first support plates 12c and the second support plates 12d are disposed opposite each other in a step type formation such that the distances between corresponding first and second support plates 12c and 12d increase as they go to the top, so that media devices 3 of diverse sizes can be held between the first and second support plates.

The first and second support plates 12c and 12d that are exactly above the first and second support plates 12c and 12d, on which the media device 3 is placed, support the side faces of the media device 3.

The first and second support plates 12c and 12d may be respectively provided with holding grooves 12e into which the respective side faces of the media device 3 are partially inserted.

The first and second support plates 12c and 12d surround partial side faces of the media device 3 that are inserted into the holding grooves 12e so as to allow the media device 3 to be held more stably and firmly.

That is, when the media device 3 is placed on any one sets of first and second support plates 12c and 12d, the side faces of the media device 3 is supported by the ends of the first and second support plates exactly above the former support plates, so that the media device 3 can be held firm.

The media device 3 including a smart phone has been released in diverse kinds of products having different screen sizes in order to satisfy the diversity of users' tastes. The media devices have different sizes depending on the sizes of their screen s.

The support part 12 can thus stably hold the smart phones of different sizes using the plurality of first and second support plates 12c and 12d.

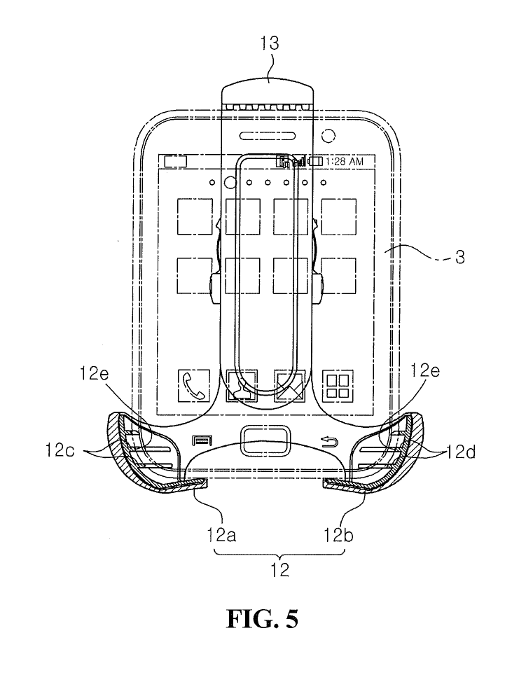

Referring to FIG. 5, the support part 12 can also stably support a curved edge portion of a media device 3 using the plurality of first and second support plates 12c and 12d.

In the holder member 10, a distance between the support part 12 and the clamp part 13 can be adjusted by moving the movable body part 14.

The holder member 10 holds a smart phone firm therein by adjusting the distance between the support part 12 and the clamp part 13 according to the size of the smart phone.

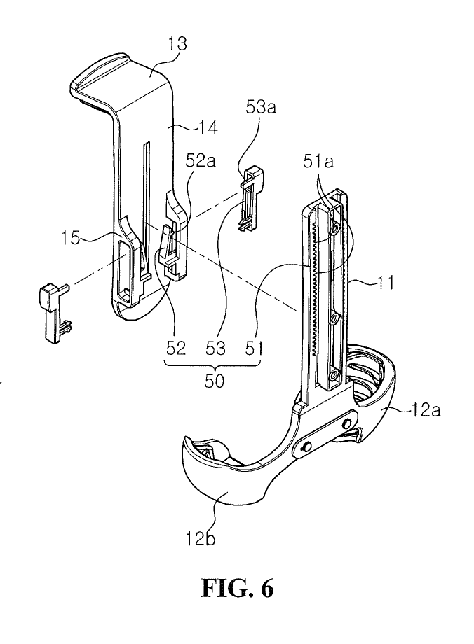

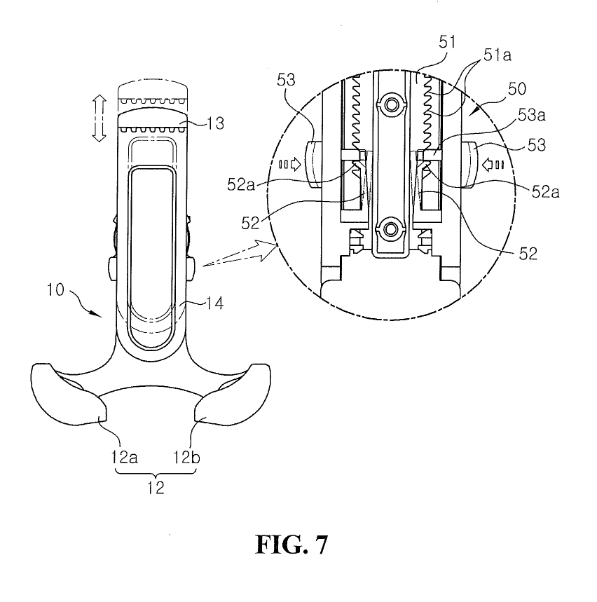

Referring to FIGS. 6 and 7, the holder member 10 may further include a lock section 50 to lock the moved position of the movable body part 14.

The lock section 50 includes a locking guider 51 having a toothed part 51a which is provided at either one of the base body part 11 and the movable body part 14 in the direction toward which the movable body part 14 moves, an elastic support piece 52 which is provided at the other one of the base body part 11 and the movable body part 14 and which has a locking protrusion 52a to mesh with the toothed part 51a, and a release button 53 which moves the elastic support piece 52 to release the lock protrusion 52a from the toothed part 51a.

The release button 53 is provided at either one of the base body part 11 and the movable body part 14 in such a manner that it is movable while being elastically supported by the elastic support piece 52. The release button 53 has a contact protrusion 53a which, when the release button is pushed, comes into contact with and pushes the elastic support piece 52.

The holder member 10 may preferably further include a pair of side guide rail parts 15 which is provided on either one of the back surface of the movable body part 14 and the front surface of the base body part 11. The pair of side guide rail parts 15 is disposed apart from each other in such a way as to support both sides of either one of the movable body part 14 and the base body part 11, guiding the movable body part 14 which moves therebetween.

The case will now be exemplified in which the side guide rail parts 15 are spaced at a distance, protruding from the back surface of the movable body part 14 such that they support the two sides of the base body part 11.

The side guide rail parts 15 support the two sides of the base body part 11 so as to allow the movable body part 14 to be smoothly moved in the vertical direction.

The case will now be exemplified in which the locking guider 51 is formed on the back surface of the base body part 11, and the elastic support pieces 52 are provided, protruding from inner sides of the side guide rail parts 15.

The lock protrusion 52a of the elastic support piece 52 is kept meshed with the toothed part 51a. When the lock protrusion 52a becomes meshed with the toothed part 51a, the position of the movable body part 14 is fixed.

When a user pushes the release button 53, the meshed lock protrusion 52a is released from the toothed part 51a. Specifically, when the user pushes the release button, the contact protrusion 53a of the release button 53 pushes the elastic support piece 52 so that the meshed lock protrusion 52a is released from the toothed part 51a. The movable body part 14 can be moved when the lock protrusion 52a is released from the toothed part 51a. When a user holds open the release button 53, the lock protrusion 52a is then inserted into and meshed with a tooth portion of the toothed part 51a by an elastic force of the elastic support piece 52.

The lock section 50 is configured such that when the user pushes the release button 53, the movable body part 14 can be moved, and when the user releases the release button 53, the movable body part 14 can be fixed to that position.

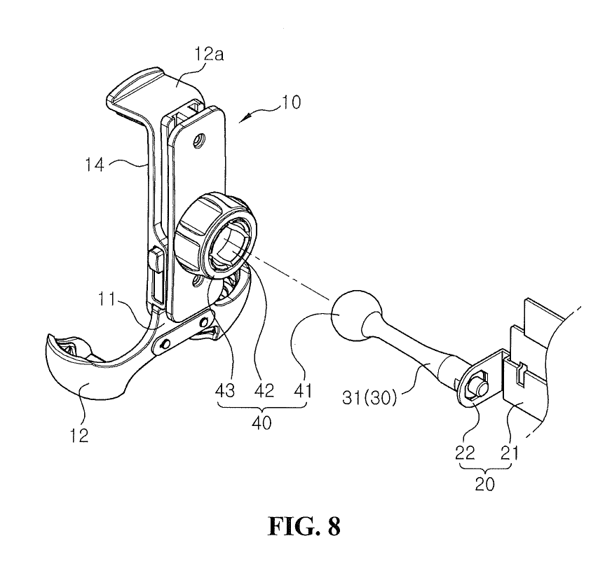

Referring to FIG. 8, the holder apparatus for a portable media device further includes a ball connector 40 which is provided at an end of the connection member 30 so as to connect the holder member 10 and the connection member 30.

The ball connector 40 includes a ball part 41 which is provided on either one of the end of the connection member 30 and the back surface of the holder member 10, a ball insert part 42 which is provided on the other one of the end of the connection member 30 and a back surface of the holder member 10 and into which the ball part 41 is inserted, and a ball-fixing nut part 43 which is screwed around the ball insert part 42 so as to fix the position of the ball part 41.

The case will be exemplified in which the ball part 41 is provided on the end of the connection member 30, and the ball insert part 42 is composed of a plurality of elastic pieces which is provided on the back surface of the holder member 10.

The ball connector 40 is operated such that, when the ball-fixing nut part 43 is unfastened from the ball insert part 42, the holder member 10 can be rotated about the ball part 41. Here, the holder member 10 can be rotated in all directions about the ball part 41.

In addition, the ball connector 40 is operated such that, when the ball-fixing nut part 43 is fastened to the ball insert part 42, the ball insert part 42 tightens the ball part 41 to fix the position of the holder member 10.

According to the holder apparatus for a portable media device, the holder member 10 can be freely moved about the ball part 41 of the ball connector 40, so that a user can adjust the direction of a screen of a media device 3 as desired.

The holder apparatus for a portable media device according to the present invention is firmly secured between the side of audio equipment of a vehicle and an instrument panel 2, having the effect of mounting a portable media device 3 in a vehicle in a simple, safe manner.

Further, the holder apparatus has the effect of simply mounting portable media devices 3 of diverse sizes without unnecessarily staining the surface of a vehicle.

Furthermore, the holder apparatus has the effect of minimizing obstructing the windshield from view, thereby improving safety while a vehicle is traveling.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A holder apparatus for mounting a media device in a vehicle, comprising:
a holder member to which the media device is detachably mounted;
a mounting bracket member mounted to a side of audio equipment of a vehicle and to which the holder member is connected; and
a connection member connecting the holder member and the mounting bracket member.

2. The holder apparatus as set forth in claim 1, wherein the mounting bracket member includes:
a bracket panel part mounted to the side of the audio equipment; and
a connection bracket part that is bent from one side of the bracket panel part.

3. The holder apparatus as set forth in claim 1, wherein the mounting bracket member is bolt-coupled to the audio equipment using a mounting hole formed at the audio equipment.

4. The holder apparatus as set forth in claim 1, wherein the holder member includes:
a base body part to which the connection member is connected;
a support part provided at a lower portion of the base body part to support a bottom of the media device; and
a clamp part provided at an upper portion of the base body part to support the top of the media device.

5. The holder apparatus as set forth in claim 4, wherein the support part includes:
a first edge support provided at one side of the lower portion of the base body part to support one side edge of the media device; and
a second edge support provided at another side of the lower portion of the base body part to support another side edge of the media device.

6. The holder apparatus as set forth in claim 5, wherein the first edge support is provided with a plurality of first support plates that are vertically arranged at distances, and the second edge support is provided with a plurality of second support plates that are vertically arranged at the same distances as those of the first support plates, wherein the distances between the plurality of first and second support plates increase from bottom to top.

7. The holder apparatus as set forth in claim 6, wherein the first and second support plates are respectively provided with holding grooves into which respective side faces of the media device are partially inserted.

8. The holder apparatus as set forth in claim 4, wherein the holder member further includes a movable body part which is movably provided at the base body part and with which either of the support part and the clamp part is integrally formed.

9. The holder apparatus as set forth in claim 8, wherein the holder member further includes a side guide rail part provided on either one of a back surface of the movable body part and a front surface of the base body part so as to guide the movement of the movable body part.

10. The holder apparatus as set forth in claim 8, wherein the holder member further includes a lock section locking the moved position of the movable body part.

11. The holder apparatus as set forth in claim 10, wherein the lock section includes:
a locking guider having a toothed part which is provided at either one of the base body part and the movable body part in the direction toward which the movable body part moves;
an elastic support piece provided at the other one of the base body part and the movable body part and having a locking protrusion meshing with the toothed part; and
a release button moving the elastic support piece so as to release the lock protrusion from the toothed part.

12. The holder apparatus as set forth in claim 1, further comprising a ball connector provided at an end of the connection member so as to connect the holder member and the connection member.

13. The holder apparatus as set forth in claim 12, wherein the ball connector includes:
a ball part provided on either one of the end of the connection member and a back surface of the holder member,
a ball insert part provided on the other one of the end of the connection member and the back surface of the holder member and into which the ball part is inserted; and
a ball-fixing nut part screwed around the ball insert part so as to fix the position of the ball part.
